(19) United States
(12) Patent Application Publication
(10) Pub. No.: US 2014/0280429 A1
(43) Pub. Date: Sep. 18, 2014

(54) Efficient Hardware Structure For Sorting/Adding Multiple Inputs Assigned To Different Bins

(71) Applicant: LSI Corporation, San Jose, CA (US)

(72) Inventors: Joseph A. Manzella, Macungie, PA (US); Michael S. Shaffer, Lynnfield, MA (US); Won J. Yoon, Ellenton, FL (US); David L. Cargille, East Windsor, NJ (US)

(73) Assignee: LSI Corporation, San Jose, CA (US)

(21) Appl. No.: 13/965,953

(22) Filed: Aug. 13, 2013

Related U.S. Application Data
(60) Provisional application No. 61/794,399, filed on Mar. 15, 2013.

(51) Int. Cl. G06F 17/10

(52) U.S. Cl. CPC G06F 17/10
USPC 708/670

(57) ABSTRACT

In one embodiment, a four-input, four-output bin adder is disclosed. The bin adder comprises a two-by-three, multi-stage, cascaded array of two-input, two-output adder circuits. Each of the bin-adder input signals comprises a numeric data value and an associated address, and the bin adder is adapted to add together (a.k.a. accumulate) the numeric values of only those inputs signals having addresses that are the same. In particular, the inputs and outputs of the two-input, two-output adder circuits are connected together in such a way that each input signal is compared to every other input signal, in a round-robin configuration. If the associated addresses match, then the input signals' numeric data values are added (i.e., accumulated) and output as a single signal comprising the sum of the numeric data values and the common address.

### BACKGROUND OF THE INVENTION

1. Field of the Invention

The present invention relates generally to bin addition (also known as grouped accumulation) and to sorting or switching a first set of inputs to a second set of outputs.

2. Description of the Related Art

In certain telecommunications and networking equipment—as well as in numerous other areas of electrical technology, including, e.g., testing and data acquisition—the equipment must receive a set of inputs, where each input has a numeric value and an associated address, and must add or accumulate together the numeric values of only those inputs having addresses that are the same. The address may represent, e.g., a specific group, bin, originating port, piece of originating equipment, etc.

One conventional method to perform such bin addition is to use a suitably programmed microcontroller or microprocessor to execute a program that compares the addresses of the inputs and accumulates the numeric values of those inputs having the same addresses. The present inventors, however, have recognized that such a solution is very time-consuming, and a significant delay over numerous clock cycles may occur before the bin-addition results are available. Accordingly, the present inventors have recognized that a fast, efficient, and hardware-based implementation of a bin adder is desirable.

### SUMMARY OF THE INVENTION

In one embodiment, the present invention is a hardware-implemented bin adder comprising a first adder circuit. The first adder circuit is adapted to receive a first input signal and a second input signal, each input signal comprising (i) a numeric data value and (ii) an address associated with the input signal. The first adder circuit is further adapted to evaluate the addresses associated with the first input signal and the second input signal. The first adder circuit is further adapted to produce a first output signal comprising (i) a sum of the numeric data values of the first and second input signals and (ii) an address corresponding to one of the addresses associated with the first input signal and the second input signal, if the addresses of the first and second input signals satisfy a predetermined criteria.

In another embodiment, the present invention is a method for performing bin addition. A first adder circuit receives a first input signal and a second input signal, each input signal comprising (i) a numeric data value and (ii) an address associated with the input signal. The addresses associated with the first input signal and the second input signal are evaluated. A first output signal comprising (i) a sum of the numeric data values of the first and second input signals and (ii) an address corresponding to one of the addresses associated with the first input signal and the second input signal is produced, if the addresses of the first and second input signals satisfy a predetermined criteria.

In still another embodiment, the present invention is hardware-implemented bin adder for comparing addresses of a plurality of bin-adder input signals and accumulating the data values of only those bin-adder input signals having matching addresses. An array of cascaded adder circuits is connected in a round-robin configuration. Each cascaded adder circuit is adapted to: receive two input signals, each input signal comprising (i) a numeric data value and (ii) an address associated with the input signal; evaluate the addresses associated with the two input signal; and produce a first output signal comprising (i) a sum of the numeric data values of the two input signals and (ii) an address corresponding to one of the addresses associated with the two input signals, if the addresses of the two input signals satisfy a predetermined criteria.

### BRIEF DESCRIPTION OF THE DRAWINGS

The above embodiments and additional embodiments are described in the following detailed description, the appended claims, and the accompanying drawings, in which like reference numerals identify similar or identical elements.

FIG. 1 is a block diagram of an exemplary four-input, four-output bin adder in accordance with one embodiment of the invention.

FIG. 2 is a block diagram of an embodiment of a cascadable, two-input, two-output adder circuit suitable for use in the bin adder shown in FIG. 1.

FIG. 3 is an exemplary flowchart depicting the operation of the adder circuit shown in FIG. 2.

FIG. 4 is an exemplary listing of pseudocode describing the operation of the adder circuit shown in FIG. 2.

FIG. 5 is a block diagram of another embodiment of a cascadable, two-input, two-output adder circuit suitable for use in the bin adder shown in FIG. 1.

FIG. 6 is an exemplary flowchart depicting the operation of the adder circuit shown in FIG. 5.

FIG. 7 is an exemplary listing of pseudocode describing the operation of the adder circuit shown in FIG. 5.

FIG. 8 is a block diagram of an exemplary three-input, three-output bin adder in accordance with another embodiment of the invention.

FIG. 9 is a block diagram of an exemplary four-input, four-output bin adder connected to a preceding sorter in accordance with another embodiment of the invention.

FIG. 10 is a block diagram of an exemplary four-input, four-output bin adder followed by a sorter in accordance with another embodiment of the invention.

FIG. 11 is a block diagram of an exemplary four-input, four-output bin adder adapted to provide a sort function in accordance with another embodiment of the invention.

FIG. 12 is a block diagram of an embodiment of a cascadable, two-input, two-output adder circuit adapted to provide a sort function and suitable for use in the bin adder shown in FIG. 11.

FIG. 13 is an exemplary flowchart depicting the operation of the adder circuit shown in FIG. 12.

FIG. 14 is an exemplary listing of pseudocode describing the operation of the adder circuit shown in FIG. 12.

### DETAILED DESCRIPTION

FIG. 1 depicts four-input, four-output bin adder 100 comprising a two-by-three, multi-stage, cascaded array of two-input, two-output adder circuits 111-116. Each of input signals 101-104 comprises a numeric data value (e.g., in_cnt0) and an associated address (e.g., in_id0). The associated address may represent or comprise, e.g., a specific group, bin, originating port, receiving port, piece of originating or receiving equipment, interrupt value, priority value, or any combination thereof. For example, in one embodiment, the associated address is a concatenation of a port address and a priority associated with the input signal.

Bin adder 100 is adapted to add together (a.k.a. accumulate) the numeric values of only those inputs signals having addresses that satisfy a predetermined criteria. The predetermined criteria may be, e.g., any combination of (i) the equality or inequality of the addresses or of a predetermined portion of the addresses, (ii) both addresses, or a predetermined portion of both addresses, being within, or outside, a predetermined range of addresses, (iii) one address, or a predetermined portion of one address, being within, or outside, a first range of addresses, and another address, were a predetermined portion of another address, being within, or outside, a second range of addresses, etc.

In one embodiment, the inputs and outputs of adder circuits 111-116 are connected together in such a way that each input signal (e.g., 101) are compared to every other input signal (e.g., 102-104), e.g., in a round-robin configuration as shown in FIG. 1. If the associated addresses satisfy the predetermined criteria (e.g., match each other), then the input signals' numeric data values are added (i.e., accumulated) and output as a single signal comprising the sum of the numeric data values and the common address. In so doing, one or more input signals will thereby become redundant and unnecessary, because such one or more input signals will have been summed with another signal having the common address. Accordingly, in one embodiment, such redundant signals are arbitrarily assigned a predetermined numeric value (e.g., 0) and a dummy address (e.g., all ones, such as binary “11111111” or hexadecimal “0xff”) and become dummy signals that continue to flow through the cascaded array of adder circuits. After the last stage of adder circuits (e.g., adder circuits 115 and 116 in Figure A), bin adder 100 then outputs the final results, accumulated according to address, as output signals 121-124, which may include one or more dummy signals.

As a simple example, one may assume that input signals 101-104 are respectively assigned addresses having address values 0, 3, 1, and 2 as indicated in Figure A, and that the numeric value of each input signal is “1”. In a first stage, adder circuit 111 evaluates whether the address of input signal 101 and the address of input signal 102 satisfy the predetermined criteria, e.g., by comparing the two addresses with each other to determine whether they are equal. Because those addresses are not equal, adder circuit 111 does not add those inputs signals together. Rather, adder circuit 111 simply passes input signal 101 to adder circuit 113 and passes input signal 102 to adder circuit 114. In a similar manner, adder circuit 112 compares the addresses of input signals 103 and 104, determines that the addresses do not match, and passes (i) input signal 103 to adder circuit 114 and (ii) input signal 104 to adder circuit 113.

In the second stage, adder circuits 113 and 114 operate similarly, with similar results, because none of the addresses of input signals 101-104 are equal. Accordingly, adder circuit 113 forwards input signal 101 to adder circuit 115 and input signal 104 to adder circuit 116, while adder circuit 114 forwards input signal 102 to adder circuit 116 and input signal 103 to adder circuit 115.

Finally, in the third stage, adder circuits 115 and 116 respectively compare the addresses of (i) signal 101 with signal 103 and (ii) signal 104 with signal 102. Once again, because none of those addresses match, signals 101-104 are output as output signals 121-124 (albeit in a different sort or port order than the original order of input signals 101-104), each still having a numeric value of “1”.

In another example, input signals 101 and 103 are assigned matching addresses (e.g., address 0). In this situation, in the first and second stages, bin adder 100 operates identically as described in the example above. In the third stage, however, adder circuit 115 determines that input signals 101 and 103 have matching addresses and therefore adds the numeric data values of the two signals together (e.g., 1+1). Adder circuit 115 then outputs the resulting accumulated numeric data value (e.g., 2) and the matched address as an output signal (e.g., output signal 121) and also outputs a dummy output signal (e.g., output signal 122), which downstream circuitry may ignore.

FIG. 2 depicts an exemplary embodiment of an adder circuit suitable for use in bin adder 100. Adder circuit 111 is representative of adder circuits 112-116 in FIG. 1. Adder circuit 111 comprises full adder 202, two multiplexers 212, 214, and decode-logic circuit 204. Adder circuit 111 receives input signal 101 comprising numeric data signal in_cnt0 (101₀) and associated address signal in_id0 (101₁), connected as shown in FIG. 2. Adder circuit 111 also receives input signal 102 comprising numeric data signal in_cnt1 (102₀) and associated address signal in_id1 (102₁), connected as shown in FIG. 2.

The operation of adder circuit 111 is depicted graphically in FIG. 3 and described using pseudocode in FIG. 4. After full adder 202 receives numeric data signals in_cnt0 and in_cnt1, it adds their values together in block 302 and generates intermediate signal sum, which is passed to multiplexer 212. In blocks 304 and 306, decode-logic circuit 204 receives input signal addresses in_id0 and in_id1 and evaluates whether they satisfy the predetermined criteria, e.g., by comparing the two addresses with each other to determine whether they are equal. If they are equal, then in block 308 decode-logic circuit 204 generates suitable control signals 206, 208 (i) to cause multiplexer 212 to select intermediate signal sum and to output it as output signal out_cnt0 and (ii) to cause multiplexer 214 to select signal 210 having a predetermined dummy value (e.g., zero) and to output it as output data signal out_cnt1. Decode-logic circuit 204 further selects the common address (e.g., the value of address signal in_id0) and outputs it as a predetermined or selected one (e.g., out_id0) of output address signals out_id0 and out_id1. Decode-logic circuit 204 also outputs a dummy address value (e.g., “11111111”) as another output address signal (e.g., output address signal out_id1).

If input signal addresses in_id0 and in_id1 are not equal, however, then in block 310 decode-logic circuit 204 generates suitable control signals 206, 208 to cause multiplexers 212 and 214 to select input data signals in_cnt0 and in_cnt1 and to output them respectively as output data signals out_cnt0 and out_cnt1. Decoder-logic circuit 204 further selects and outputs the value of address signal in_id0 as output address signal out_id0, and it selects and outputs the value of address signal in_id1 as output address signal out_id1. Output signals out_cnt0, out_id0, out_cnt1, and out_id1 are then passed to downstream circuitry.

In the embodiment of adder circuit 111 described above, if the dummy address value is unique and not equal to any valid input address, then the dummy address value (e.g., “11111111”) may be used by downstream circuitry to determine whether output signals out_cnt0, out_id0, out_cnt1, and out_id1 represent valid data and valid addresses.

A summary of the inputs and outputs of adder circuit 111 is provided below:
Inputs:
   in_id0: Input ID for input 0
   in_id1: Input ID for input 1
   in_cnt0: Input Count/numeric data value for input 0
   in_cnt1: Input Count/numeric data value for input 1
Outputs:
   Out_cnt0: Output 0; this output has a value of the sum of in_cnt0+in_cnt1, if (in_id0=in_id1); or in_cnt0, if (in_id0≠in_id1).
   Out_cnt1: Output 1; this output has a value of zero, if (in_id0=in_id1); or in_cnt1, if (in_id0≠in_id1).
   Out_id0: Output ID/address for out_cnt0.
   Out_id1: Output ID/address for out_cnt1; or all ones, if (in_id0=in_id1).

FIG. 5 depicts another embodiment of adder circuit 111, which embodiment will be identified herein as adder circuit 500. Like adder circuit 111, adder circuit 500 comprises full adder 502, two multiplexers 512, 514, and decode-logic circuit 504. Adder circuit 500 similarly receives input signal 101 comprising numeric data signal in_cnt0 (101₀) and associated address signal in_id0 (101₁), connected as shown in FIG. 5. Adder circuit 500 also receives input signal 102 comprising numeric data signal in_cnt1 (102₀) and associated address signal in_id1 (102₁), connected as shown in FIG. 5.

In adder circuit 500, however, the validity of the input and output signals is indicated expressly by additional signals. In particular, in this embodiment, input signal 101 also comprises validity signal in_valid0 (101₂), and input signal 102 also comprises validity signal in_valid1 (102₂), as shown in FIG. 5.

The operation of the embodiment of adder circuit 500 of FIG. 5 is depicted graphically in FIG. 6 and described using pseudocode in FIG. 7. Full adder 502 receives numeric data signals in_cnt0 and in_cnt1, adds their values together in block 602 and generates intermediate signal sum, which is passed to multiplexer 512. In blocks 504 and 506, decode-logic circuit 504 receives input signal addresses in_id0 and in_id1 and evaluates whether they satisfy the predetermined criteria, e.g., by comparing the two addresses to determine whether they are equal. In this embodiment, however, in block 506, decode-logic circuit 504 also determines whether validity signals in_valid0 and in_valid1 are both valid. If the input signal addresses are the same and both validity signals are valid, then in block 608 decode-logic circuit 504 generates suitable control signals 506, 508 (i) to cause multiplexer 512 to select intermediate signal sum and to output it as output signal out_cnt0 and (ii) to cause multiplexer 514 to select signal 510 having a predetermined dummy value (e.g., zero) and to output it as output data signal out_cnt1. Decode-logic circuit 504 further selects the common address (e.g., the value of address signal in_id0), outputs it as a predetermined or selected one (e.g., out_id0) of output address signals out_id0 and out_id1, and generates a corresponding output validity signal (e.g., out_valid0) with a value (e.g., 1) that indicates that the predetermined or selected output signal (e.g., out_id0) is valid. Decode-logic circuit 504 also outputs a dummy address value (e.g., “11111111”) as a second output address signal (e.g., output address signal out_id1) and generates a corresponding output validity signal (e.g., out_id1) having a value (e.g., 0) that indicates that the second output signal (e.g., out_id1) does not represent a valid signal.

If input signal addresses in_id0 and in_id1 are not equal, or if one or both of the validity signals indicate that one or both of the input signals are not valid, then in block 610 decode-logic circuit 504 generates suitable control signals 506, 508 to cause multiplexers 512 and 514 to select input data signals in_cnt0 and in_cnt1 and to output them respectively as output data signals out_cnt0 and out_cnt1. Decoder-logic circuit 504 further selects and outputs the value of address signal in_id0 as output address signal out_id0, and it selects and outputs the value of address signal in_id1 as output address signal out_id1. Decoder-logic circuit 504 further selects and outputs the value of input validity signal in_valid0 as output validity signal out_valid0, and it selects and outputs the value of input validity signal in_valid1 as output validity signal out_valid1. Output signals out_cnt0, out_id0, in_valid0, out_cnt1, out_id1, and in_valid1 are then passed to downstream circuitry.

FIG. 8 depicts three-input, three-output bin adder 800 in accordance with another embodiment of the invention. Like bin adder 100, bin adder 800 comprises three cascaded stages, which include an array of cascaded adder circuits 812, 813, and 815 connected in a round-robin configuration, such that (i) each input signal is compared to every other input signal and (ii) input signals having matching addresses are added together. Because bin adder 800 has an odd number of inputs, however, adder circuits 111, 114, and 116 in bin adder 100 are replaced by delay elements 802-804 in bin adder 800.

The inventors have further recognized that, in certain applications, the ability to sort the input signals (which may be associated with a specific incoming port), according to their respective associated addresses or some other sorting scheme, is desirable. Accordingly, FIG. 9 and FIG. 10 illustrate how a bin adder such as bin adder 100 or bin adder 800 may be connected to a sorter unit 902, 1002, in order to adjust the order in which the input signals are ultimately outputted, or, alternatively, the port on which the input signals are outputted. For example, in FIG. 9, sorter unit 902 is applied to the input signals, before those signals are provided to the first stage of the bin adder. In FIG. 10, sorter unit 1002 is applied to the output signals of the bin adder. Each of sorter units 902, 1002 may be implemented in a conventional manner using a set of four 4-to-1 multiplexers that permit any input signal to be output on any output port. Each of sorter units 902, 1002 may also be connected to a controller or processor (not shown) adapted to control and/or adjust the port upon which each input signal is output.

FIG. 11 depicts a sorting bin adder 1100 in accordance with another embodiment of the invention. Like bin adder 100, sorting bin adder 1100 comprises a plurality of cascaded stages formed by an array of adder circuits 1141-1146 connected in a round-robin configuration, such that: (i) the address of each input signal among input signals 1102-1105 can be compared with the address of every other input signal, and (ii) their respective data values can be combined and accumulated if their addresses satisfy a predetermined criteria. Adder circuits 1141-1146, however, provide not only an adding function but also a sorting function, under the control of a control signal feedback_ctl generated by a controller or processor (not shown). Sorting bin adder 1100 also comprises a plurality of two-input multiplexers 1121-1124, each having a first input adapted to receive one of input signals 1102-1105 and a second input adapted to receive one of output signals 1151-1154 through register 1160.

Thus, sorting bin adder 1100 is adapted to operate in one of two modes: a summing mode and a sorting mode, as determined by the state of control signal feedback_ctl. In the summing mode, control signal feedback_ctl configures multiplexers 1121-1124 to select input signals 1102-1105 and to pass those input signals onto the first adder stage comprising adder circuits 1141 and 1142. Adder circuits 1141-1146 then operate in the same way as adders 111-116 in bin adder 100 described above, in order to evaluate the addresses of the input signals to determine whether they satisfy the predetermined criteria, accumulate the data values of those input signals satisfying the predetermined criteria, and output the accumulated signals as output signals 1151-1154.

After adder circuits 1141-1146 finish the summing operation, the controller or processor converts sorting bin adder 1100 to the sorting mode, by adjusting control signal feedback_ctl to cause multiplexers 1121-124 to select output signals 1151-1154 as the new input signals 1131-1134 for adder circuits 1141-142. In one embodiment, the controller or microprocessor is adapted to select a predetermined sort order that may be based on, e.g., one or more of: the addresses or data values of input signals 1102-1105 or output signals 1151-154, the specific ports upon which input signals 1102-1105 were received, a priority associated with the input signals, or some other sorting scheme. The controller or microprocessor then provides one or more sort-configuration signals to adder circuits 1141-1146 to configure them to implement the selected or predetermined sort order. Finally, adder circuits 1141-1146 perform a sort operation accordingly and generate output signals 1151-154 in the selected sort order.

FIG. 12 provides further details regarding the architecture of an exemplary adder circuit 1141 suitable for use in sorting bin adder 1100. Like adder circuit 500, adder circuit 1141 comprises full adder 1202, two multiplexers 1212, 1214, and decode-logic circuit 1204. Adder circuit 1141 similarly receives (i) input signal 1102 comprising numeric data signal in_cnt0 (1102₀), address signal in_id0 (1102₁), and validity signal in_valid0; and (ii) input signal 1103 comprising numeric data signal in_cnt1 (1103₀), address signal in_id1 (1103₁), and validity signal in_valid1 (1103₂), connected as shown in FIG. 12. In addition, adder circuit 1141 also receives control signal feedback_ctl from the controller or processor (not shown) and may also receive sort-order control signals sort_id0 and sort_id1 therefrom. In an alternative embodiment, sort-order control signals sort_id0 and sort_id1 are connected to, and therefore derived from, input address signals in_id0 and in_id1.

The operation of adder circuit 1141 is depicted graphically in FIG. 13 and described using pseudocode in FIG. 14. In block 1312, decode-logic circuit 1204 determines, based on the state of control signal feedback_ctl, whether adder circuit 1141 should perform a summing operation or a sorting operation. If a summing operation is selected, then the sort function is not enabled, and adder circuit 1141 operates identically to adder circuit 500 described above. Thus, blocks 1302, 1304, 1306, 1308, and 1310 in FIG. 13 are identical to block 602, 604, 606, 608, and 610 shown in FIG. 6.

If, however, decode-logic circuit 1204 determines in block 1312 that adder circuit 1141 is to perform a sorting operation, then, in block 1314, decode-logic circuit 1204 evaluates whether either of the input address signals in_id0 and in_id1 (or a predetermined portion of the input address signals) matches either of the sort-order control signals sort_id0 and sort_id1.

If neither input address signal matches one of the sort-order control signals, then, in block 1310, decode-logic circuit 1204 produces suitable control signals 1206 and 1208 to cause multiplexers 1212 and 1214 to pass the input data signals in_cnt0 and in_cnt1 through the multiplexers, in order to produce output data signals out_cnt0 and out_cnt1, respectively. Decoder-logic circuit 1204 further selects and outputs the value of address signal in_id0 as output address signal out_id0, and it selects and outputs the value of address signal in_id1 as output address signal out_id1. Decoder-logic circuit 1204 further selects and outputs the value of input validity signal in_valid0 as output validity signal out_valid0, and it selects and outputs the value of input validity signal in_valid1 as output validity signal out_valid1.

On the other hand, if one of the input address signals in_id0 and in_id1 matches one of the sort-order control signals sort_id0 and sort_id1, then operation proceeds from block 1314 to block 1316. Decode-logic circuit 1204 essentially causes adder circuit 1141 to operate as a crossbar switch, such that adder circuit 1141 swaps the outputs. Thus, in block 1316, decode-logic circuit 1204 produces suitable control signals 1206 and 1208 to cause multiplexers 1212 and 1214 to pass the input numeric data signals in_cnt0 and in_cnt1 through the multiplexers, in order to produce output data signals out_cnt1 and out_cnt0, respectively. Decoder-logic circuit 1204 further selects and outputs the value of address signal in_id0 as output address signal out_id1, and it selects and outputs the value of address signal in_id1 as output address signal out_id0. Decoder-logic circuit 1204 further selects and outputs the value of input validity signal in_valid0 as output validity signal out_valid1, and it selects and outputs the value of input validity signal in_valid1 as output validity signal out_valid0. Output signals out_cnt0, out_id0, in_valid0, out_cnt1, out_id1, and in_valid1 are then passed to downstream circuitry.

In this manner, any given input signal of sorting bin adder 1100 may be systematically or even arbitrarily shunted upward or downward in the array of bin adders 1141-1146, so that any of input signals 1102-1105 can be output on any of output lines 1151-1154.

It should be recognized that the bin adders described above are not restricted to the circuit array sizes shown in FIGS. 1 and 8-11. Rather, adder circuits 111, 500, 1141 may be used to construct larger arrays that are similarly connected in a round-robin configuration, such that (i) the address of each input may be compared to the address of every other input and (ii) the data values of inputs having matching addresses may be accumulated. Table 1 below illustrates the number of adder circuit stages and total number of adder circuits that can be used to construct higher-order bin adders.

TABLE 1

| | | Total Number of |
|---|---|---|
| Number of | Number of Adder | Adders |
| Outputs (N) | Stages | 2: (N − 1)(N/2) |
| 2 | 1 | 1 |
| 3 | 3 | 2 |
| 4 | 3 | 6 |
| N even | (N − 1) | (N − 1)(N/2) |
| N odd | N | (N − 1)(N/2) |

In general, the adder circuits 111, 500, and 1141 can be cascaded using a generic round-robin tournament scheduling algorithm that ensures that every input signal is compared to every other input signal. See, e.g., http://en.wikipedia.org/wiki/Round-robin_tournament dated Mar. 15, 2013, which is hereby incorporated by reference in its entirety. For example, for a 14-signal bin adder having input signals identified as [1, 2, 3, 4, 5, 6, 7, 8, 9, 10, 11, 12, 13, 14], the first stage would be as follows:

Stage 1. 1 is compared to 14, 2 is compared to 13, etc.:

| 1 | 2 | 3 | 4 | 5 | 6 | 7 |
|---|---|---|---|---|---|---|
| 14 | 13 | 12 | 11 | 10 | 9 | 8 |

In the second and subsequent stages, one of the 14 signals (e.g., signal 1, as indicated by bold typeface below) is fixed in position, and the remaining signals are translated or rotated by one position:

Stage 2. 1 is compared to 13, 14 is compared to 12, etc.:

| 1 | 14 | 2 | 3 | 4 | 5 | 6 |
|---|---|---|---|---|---|---|
| 13 | 12 | 11 | 10 | 9 | 8 | 7 |

Stage 3. 1 is compared to 12, 13 is compared to 11, etc.:

| 1 | 13 | 14 | 2 | 3 | 4 | 5 |
|---|---|---|---|---|---|---|
| 12 | 11 | 10 | 9 | 8 | 7 | 6 |

The translation or rotation is continued until the final position is reached:

Stage 13. 1 is compared to 2, 3 is compared to 14, etc.:

| 1 | 3 | 4 | 5 | 6 | 7 | 8 |
|---|---|---|---|---|---|---|
| 2 | 14 | 13 | 12 | 11 | 10 | 9 |

If there are an odd number of signals, a dummy signal can be added, which in any given stage simply advances to the next stage. The comparison schedule can therefore be computed as though the dummy signal were an ordinary signal, either fixed or rotating. Thus, the bin adders shown in FIGS. 1 and 9-11, which have an even number of input signals, may easily be used with an odd number of input signals by adding one additional dummy signal. For example, the dummy signal may be assigned an input data value in_cntx equal to zero, an input address in_idx equal to a unique dummy value (e.g., all ones), and an invalidity signal equal to a value that indicates that the dummy signal is invalid (e.g., 0).

In addition, instead of translating or rotating only by one position in each stage, any number that is relatively prime to n−1 will generate a complete comparison schedule.

Assuming that the algorithm is implemented in hardware as parameterized code, then an embodiment of the parameterized code that implemented n−1 stages with a translation or rotation before the first stage and between each stage similar to the translation or rotation above could take the following form:
input→shuffle→compare (0/n−1, 1/n−2, 2/n−3, . . . )→shuffle→→compare (0/n−1, 1/n−2, 2/n−3, . . . )→ . . . .
   The translation or rotation may be implemented as a simple re-assignment, as follows:
Out [0]=in [0];
Out [1]=in [n−1];
Out [2]=in [1]; . . .
Out [n−1]=in [n−2];

Advantageously, in the embodiments depicted in FIGS. 1 and 8-11, bin addition for a given set of input signals may be performed within a single clock cycle. If the embodiment depicted in FIG. 11 is used alternately for bin addition and output sorting in a repeating sequence, however, then control signal feedback_ctl is preferably derived from logic that runs at twice the data rate of the input signals.

It will be understood that the output data signals described above are preferably sized sufficiently large to ensure that an overflow does not occur if all of the input signals are summed to the same output signal.

It should also be understood that the present invention is not limited to a two-input, two-output adder circuit as depicted in the figures and as described above. Rather, the present invention may be implemented using a multiple-input adder circuit having more than two inputs, such as a three-input adder circuit or a four-input adder circuit.

The present invention may be implemented as analog, digital, or a hybrid of both analog and digital circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

For purposes of this description, the term “address” is not limited to a memory or port address but rather refers to any unique identifier.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Signals and corresponding nodes or ports may be referred to by the same name and are interchangeable for purposes here.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values stored in a non-transitory recording medium generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

We claim:

1. A hardware-implemented bin adder, comprising:
a first adder circuit adapted to:
receive a first input signal and a second input signal, each input signal comprising (i) a numeric data value and (ii) an address associated with the input signal;
evaluate the addresses associated with the first input signal and the second input signal;
produce a first output signal comprising (i) a sum of the numeric data values of the first and second input signals and (ii) an address corresponding to one of the addresses associated with the first input signal and the second input signal, if the addresses of the first and second input signals satisfy a predetermined criteria.

2. The invention of claim 1, wherein the first adder circuit is adapted to produce a first output signal equal to the first input signal and a second output signal equal to the second input signal, if the addresses of the first and second input signals fail to satisfy the predetermined criteria.

3. The invention of claim 1, wherein the first adder circuit is adapted to produce a predetermined second output signal, if the addresses of the first and second input signals satisfy the predetermined criteria.

4. The invention of claim 1, further comprising:
a second adder circuit adapted to:
receive a third input signal and a fourth input signal, each input signal comprising (i) a numeric data value and (ii) an address associated with the input signal;
compare the addresses associated with the third input signal and the fourth input signal;
produce a second output signal comprising (i) a sum of the numeric data values of the third and fourth input signals and (ii) an address corresponding to one of the addresses associated with the first input signal and the second input signal, if the addresses of the first and second input signals satisfy a predetermined criteria.

5. The invention of claim 4, further comprising:
a third adder circuit connected to the first adder circuit and the second adder circuit and adapted to:
receive, as input signals, the first output signal from the first adder circuit and the second output signal from the second adder circuit;
compare the addresses associated with the first and second output signals;
produce a third output signal comprising a sum of the numeric data values of the third and fourth input signals, if the addresses of the third and fourth input signals satisfy a predetermined criteria.

6. A method for performing bin addition, the method comprising:
a first adder circuit receiving a first input signal and a second input signal, each input signal comprising (i) a numeric data value and (ii) an address associated with the input signal;
evaluating the addresses associated with the first input signal and the second input signal; and
producing a first output signal comprising (i) a sum of the numeric data values of the first and second input signals and (ii) an address corresponding to one of the addresses associated with the first input signal and the second input signal, if the addresses of the first and second input signals satisfy a predetermined criteria.

7. The invention of claim 6, further comprising producing a first output signal equal to the first input signal and a second output signal equal to the second input signal, if the addresses of the first and second input signals fail to satisfy the predetermined criteria.

8. The invention of claim 6, further comprising producing a predetermined second output signal, if the addresses of the first and second input signals satisfy the predetermined criteria.

9. The invention of claim 6, further comprising:
a second adder circuit receiving a third input signal and a fourth input signal, each input signal comprising (i) a numeric data value and (ii) an address associated with the input signal;
comparing the addresses associated with the third input signal and the fourth input signal; and
producing a second output signal comprising (i) a sum of the numeric data values of the third and fourth input signals and (ii) an address corresponding to one of the addresses associated with the first input signal and the second input signal, if the addresses of the first and second input signals satisfy a predetermined criteria.

10. The invention of claim 9, further comprising:
a third adder circuit receiving, as input signals, the first output signal from the first adder circuit and the second output signal from the second adder circuit;
comparing the addresses associated with the first and second output signals;
producing a third output signal comprising a sum of the numeric data values of the third and fourth input signals, if the addresses of the third and fourth input signals satisfy a predetermined criteria.

11. A hardware-implemented bin adder for evaluating addresses of a plurality of bin-adder input signals and accumulating the data values of only those bin-adder input signals having addresses that meet a predetermined criteria, the hardware-implemented bin adder comprising:
an array of cascaded adder circuits connected in a round-robin configuration, wherein each cascaded adder circuit is adapted to:
receive two input signals, each input signal comprising (i) a numeric data value and (ii) an address associated with the input signal;
evaluate the addresses associated with the two input signals;
produce a first output signal comprising (i) a sum of the numeric data values of the two input signals and (ii) an address corresponding to one of the addresses associated with the two input signals, if the addresses of two input signals satisfy a predetermined criteria.
